(19) United States
(12) Patent Application Publication
(10) Pub. No.: US 2008/0053381 A1
(43) Pub. Date: Mar. 6, 2008

(54) Hairpiece for pets

(76) Inventor: Ruth Regina, Miami, FL (US)

Correspondence Address: MALLOY & MALLOY, P.A.;Historic Coral Way, 2800 S.W. Third Avenue, Miami, FL, 33129, US

(21) Appl. No.: 11/888,644

(22) Filed: Aug. 1, 2007

Related U.S. Application Data
(60) Provisional application No. 60/835,021, filed on Aug. 1, 2006.

(51) Int. Cl. A01K 13/00

(52) U.S. Cl. 119/850

(57) ABSTRACT

A hairpiece assembly structured for mounting on predetermined body portions, including the head portion of a pet such as a dog, cat, etc. A foundation includes a base and first and second connecting members secured to the base and disposed, dimensioned and structured to at least partially surround the body portion thereby retaining the base in its intended orientation on the predetermined body portion of the pet. At least two stabilizing members define a part of the foundation and are disposed in spaced relation to different sides of the base so as to form spaced apart receiving apertures. The receiving apertures are disposed and dimensioned to allow passage of any, correspondingly disposed and associated body components, such as the ears of the head portion, there through thereby serving to stabilize the foundation in its intended orientation on the pet.

### CLAIM OF PRIORITY

The present application is based on and a claim of priority is made under 35 U.S.C. Section 119(e) to a provisional patent application that is currently pending in the U.S. Patent and Trademark Office, namely, that having Ser. No. 60/835,021 and a filing date of Aug. 1, 2006.

### BACKGROUND OF THE INVENTION

1. Field of the Invention

The present invention relates to a hairpiece to be worn by a pet such as, but not necessarily limited to, a dog or cat, so as to provide an enhanced or decorative appearance to the pet while still permitting the pet to be substantially comfortable and retain normal, uninterrupted hearing, vision, breathing, eating and vocalization.

2. Description of the Related Art

Pet toys and pet fashion accessories are a significant niche market with ever increasing product lines dedicated to allowing sophisticated pet owners to show off and/or otherwise enhance the appearance of their pet, in either highly attractive, highly fashionable, or whimsical manners. In this regard for example, there are a large variety of different types of decorative pet collars, pet jewelry and pet clothing taking on a number of different fashion configurations akin to traditional human fashioned items.

Additionally, there are a variety of different types of hats which are made available as a clothing item for pets, wherein the hats provide a decorative enhancement and/or function to keep the pet's head warm in cold climates. Typically, however, pet hats are configured to be tied on in a generally loose fitting manner in that the primary purpose of the hat is to make it a distinctive part of the pet's appearance as versus it trying to blend in with a part of the pet's anatomy.

As a result, it would be highly beneficial and attractive to provide a hairpiece for a pet which can be effectively and comfortably secured to the pet in a manner that will facilitate it blending in with the pet's normal fur or other textured natural coat. Such a proposed hairpiece would be preferably structured to give the outward appearance that the real or artificial hair that comprises the hairpiece is actually a part of the pet or is apparently and truly extending from the pet.

It would also be beneficial to provide a hairpiece for pets which does not impede or otherwise hinder the normal sensibilities of the pet, including breathing, hearing, vision, eating and vocal functions of the pet. As such, pets would be much more inclined to wear the hairpiece for an extended period of time, as their hearing, vision and ability to breath, vocalize and/or eat would not be otherwise impeded. Further, it would be beneficial to provide such a hairpiece for pets which can be securely maintained in an intended position and orientation on the pet, even as the pet walks, runs or otherwise moves about. The proposed pet hairpiece would thereby always be maintained in its predetermined and presumably most attractive and ideal orientation, while concurrently minimizing the potential for the hairpiece to become bothersome to the pet.

### SUMMARY OF THE INVENTION

The present invention relates to a hairpiece for a pet. Preferably, the hairpiece is to be worn primarily, but not necessarily exclusively, on and/or adjacent to the pets head. While the pet for which the hairpiece is primarily structured may include a dog or a cat, it is noted that a variety of other, different animal types may also utilize the present hairpiece. Accordingly, it is to be noted that the various preferred embodiments of the present invention may vary in dimension, configuration and structure to accommodate pets of different sizes, animal species, etc.

More specifically, one or more preferred embodiments of the hairpiece of the present invention may include a foundation which is configured to be secured to the pet, such as on or at least adjacent to the pet's head or other predetermined body portion. Further, the foundation is structured to provide a fastening and/or support structure for a plurality of hair segments, as described n greater detail hereinafter. In this regard, one preferred embodiment includes the foundation comprising a base which may have an elliptical or other appropriate configuration. As such, the base and other parts of the foundation are preferably dimensioned and configured to follow the contour of the head while achieving a comfortable, secure and exacting fit.

Included as part of the foundation is at least a first connecting member preferably in the form of an elongated forwardly located band element structured to be disposed in at least partially surrounding, snuggly securing relation to the pet's head or other predetermined body portion. More specifically the first connecting member or forward band element is of sufficient length to extend preferably below the chin and atop the head at a point above the eyes and forward of the pet's ears, when the foundation id mounted on the pet's head. The foundation further comprises a second connecting member preferably in the form of a rear band. The second connecting member or rear band element also extends in at least partially surrounding relation around the pet's head, behind the ears and substantially about the neck region of the pet. As used herein the term “head portion” of the pet is meant to include this neck region engaged by the second connecting member, as will be explained in greater detail herein after. As such, the cooperative positioning and structuring of the first and second connecting members provide two effective fastening locations of the foundation, on the pet's head.

Looking further to the foundation, at least one but preferably a pair of stabilizing members may also be provided, in interconnecting relation between the first and second connecting members and in spaced relation to each of the opposite sides of the base. Moreover, each of the stabilizing members extends rearward from the first connecting member or forward band into secure engagement with second connecting member or rear band element. The disposition of the stabilizing members relative to the base serves to at least partially define two receiving apertures each located on an opposite side of the base and between the first and second connecting members. As a result the receiving apertures are disposed, dimensioned and configured to facilitate the passage of the pet's ears there through. Accordingly, the apertures are substantially defined by corresponding ones of the stabilizing members, the periphery of the base and the first and second connecting members.

In at least one preferred embodiment, at least the base is formed of a material having an open mesh and/or net-like construction, which may or may not be at least partially flexible. Such structuring of the base, as well as possibly other components of the foundation, provides a durable, possibly expandable fit. Moreover, the use of open mesh material in the base or other components of the foundation facilitates the foundation adapting to the shape of the body portion of the pet which it engages. For example, the forward and rear band elements defining the first and second connecting members preferably include elastic characteristics and possibly the aforementioned open mesh and/or net like material construction so as to achieve a snug yet not overly tight fit on the pet's head or other body portion. As will be explained in greater detail hereinafter the open mesh structuring of the base and other parts of the foundation also facilitates the attachment of a plurality of hair segments which define the hair display of the hairpiece.

However, the base, as well as other parts of the foundation can be made of any of a variety of materials and be integral with or fixedly secured to one another. By way of example only, additional preferred embodiments of the base comprise it being made out of denim or poly-cotton fabric fastened to or integrated with elastic segments, bands or like structures that form the first and second connecting members and stabilizing members. In addition, the base can be structured to include any of a variety of colors, patterns, sizes and configurations in order to provide a desired appearance of the hairpiece of the present invention and/or to allow it to substantially blend with the normal hair or fur of the pet. As a result, the precise location and orientation of the foundation relative to the body portion of the pet on which it is connected can be occluded or masked resulting in a more realistic appearance of the pet.

Also, it is emphasized that the preferred open mesh or net-like structuring of the base, as well as other parts of the foundation, facilitates the blending of the pets own hair or fur with the foundation by allowing the pets fur, etc. to pass through the open mesh structure, in a manner which should be apparent. Additionally, the colors of the base and/or foundation might be defined so as to blend with natural hair colors and/or the color of the hair segments to be secured to the foundation, such as black, brown, red or blonde. Of course any of a variety of other colors may also be provided.

In addition and as set forth above, a plurality of hair segments are preferably secured at least to the base portion of the foundation in a predetermined quantity, thereby determining the density of the hair display of the hairpiece. Moreover, the attached hair segments may vary in size, length and color, so as to meet the decorative and/or fashion desires of the consuming public. Furthermore, the hair segments can be made of natural human or animal hair and/or synthetic hair or other synthetic hair like materials. Also, a variety of decorative items may be also incorporated in with the hair segments, such as beads, braids and other decorative or utilitarian devices.

As a result, the present hairpiece for pets, which can come in a variety of different sizes to accommodate small, medium and large pets, provides a sophisticated and attractive enhancement for the appearance of pets, and possibly in some instances wherein pets have exhibited hair loss, so as to mask that hair loss. Further, the pet hairpiece of the present invention can be directly coordinated with a variety of accessory items and/or be the only signature accessory item to provide for an attractive appearance enhancement for the pet. Indeed, it is recognized that although the present hairpiece for pets is designated in a preferred embodiment for securement to the head of the pet, it is also understood and recognized that the same configuration can be expanded over various other portions of the body of the pet.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side perspective view in partial cutaway of a foundation of the hairpiece assembly of the present invention on a head of a pet, wherein the foundation is absent the normally attached plurality of hair segments.

FIG. 2 is a top view of the embodiment of FIG. 1.

FIG. 3 is a side perspective view similar to that of FIG. 1, but including a plurality of hair segments attached to the foundation in overlying and/or covering relation to the head portion of the pet and there by at least partially defining a predetermined display of hair.

FIG. 4 is a top perspective view in partial cutaway of the embodiment of FIG. 2 with a plurality of hair segments attached to the foundation and thereby at least partially defining a predetermined display of hair.

FIG. 5 is a perspective view in partial cutaway of the plurality of hair segments attached to various portions of the foundation.

FIG. 6 is a top view in partial cutaway of yet another embodiment of the foundation from that represented in FIGS. 1-4.

FIG. 7 is a detail view of one or both of a first and/or second connecting member comprising a part of the foundation of the hairpiece.

FIG. 8 is another embodiment of the first and/or second connecting member similar to but distinguishable from the embodiment of FIG. 7.

Like reference numerals refer to like parts throughout the several views of the drawings.

### DETAILED DESCRIPTION OF THE PREFERRED EMBODIMENT

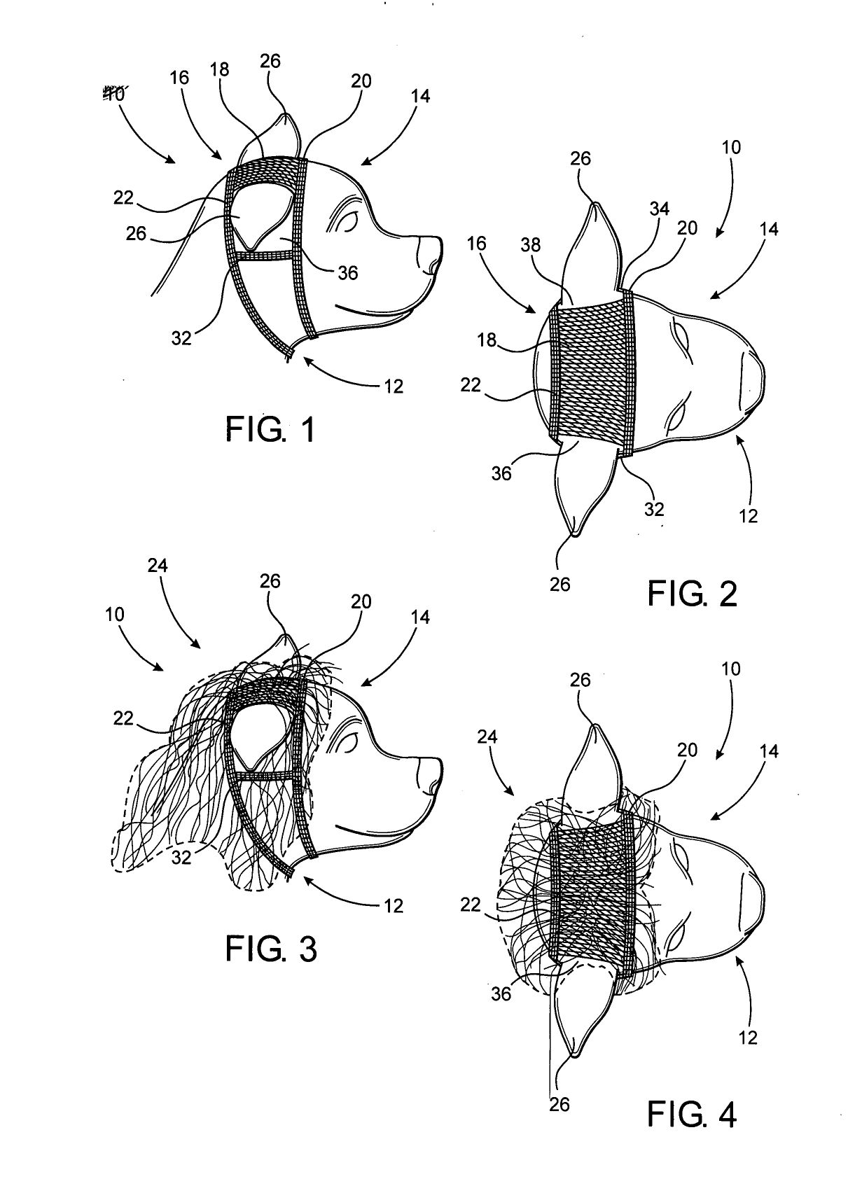

As shown in the accompanying drawings, the present invention is directed to a hairpiece generally indicated as 10 and structured for use on a pet 12. As demonstrated in FIGS. 1-4, the predetermined portion of the pet 12 to which the hairpiece 10 is attached is the head 14. As such, the term “head” or “head portion” is meant to describe the head 14 of the pet 12 as well as adjacent, surrounding and/or directly associated parts of the head 14 which may be utilized to secure, retain or otherwise appropriately position the hairpiece assembly 10 in its intended location and orientation. However, it is emphasized that the hairpiece assembly 10 may be attached to other predetermined portions of the pet 12, other than the head 14. Such additional body portions may include, but not be limited to areas about the neck or throat, the shoulders, back and/or under portions of the pet as well as the tail, hind quarters and other appropriate portions of the pet 12. Accordingly, it is recognized that it may be desirable for a variety of reasons, including a decorative standpoint, to add additional hair to many other portions of the pet's body utilizing the one or more preferred embodiments of the hairpiece of the present invention.

Accordingly, as represented in FIGS. 1-4, at least one preferred embodiment of the present invention represents the hairpiece assembly 10 as including a foundation generally indicated as 16. The foundation 16 includes a base 18 and a first connecting member and a second connecting member 20 and 22 respectively. The first and second connecting members 20 and 22 are connected in spaced apart relation on substantially opposite portions of the base 18. In addition, each of the first and second members 20 and 22 is disposed in retaining relation to the base 18 when they are secured about the head 14 or other predetermined body portion of the pet 12.

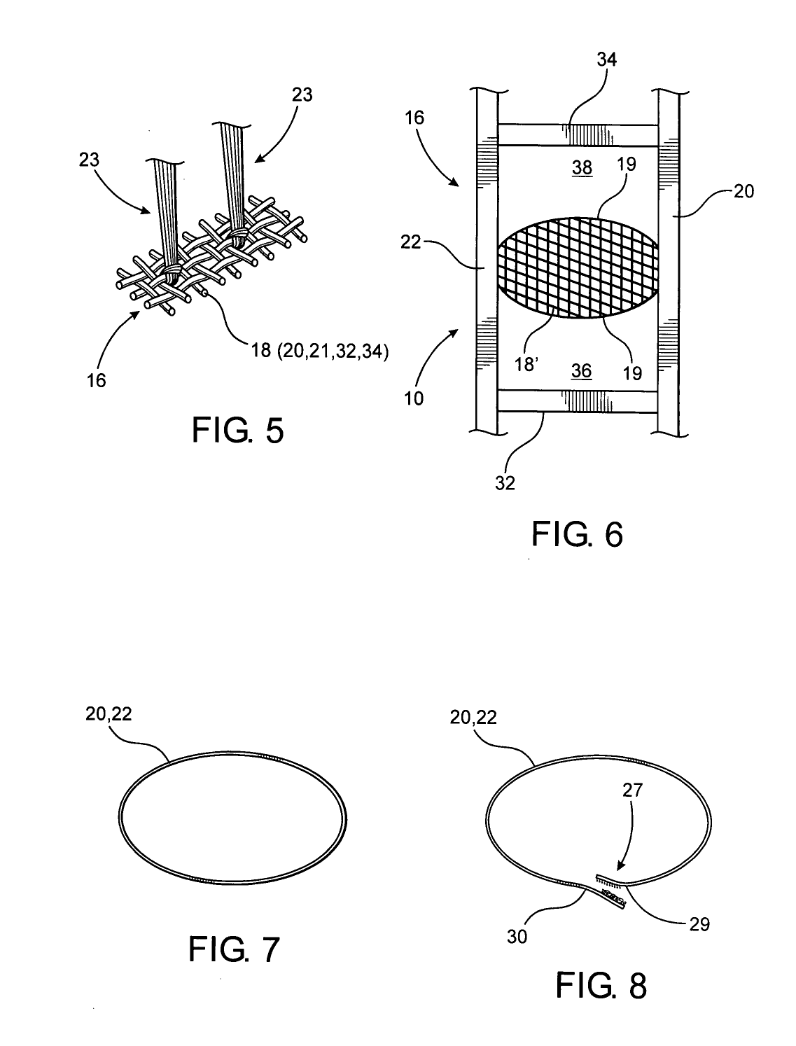

For purposes of clarity, FIGS. 1 and 2 represent the foundation 16 absent any hair or more specifically, absent the attachment of any of a plurality of hair segments 23, as represented in FIG. 5. When attached to the foundation 16, the hair segments 23 collectively represent a display of hair, generally indicated as 24 in FIGS. 3 and 4. The display of hair 24 may have a predetermined or selected density depending upon the desires or preference of the user of the hair piece assembly 10. Further, the selected density or of the hair display 24 is dependent upon the number and/or structuring of the hair segments 23 attached to the foundation 16, as will also be explained in greater detail hereinafter.

Again with primary reference to FIGS. 1 and 2, the first and second connecting members 20 and 22 may be in the form of straps, lines, bands, or other appropriate connecting structures which have a substantially elongated configuration. Dependent upon a particular embodiment, as represented in FIGS. 7 and 8, at least one but preferably both of the first and second connecting members 20 and 22 may at least partially, but preferably completely surround the head portion 14 of the pet 12. Such an at least partially surrounding orientation of the connecting members 20 and 22 serves to retain the base 18 in its intended, overlying position relative to the top of the head 14 as clearly demonstrated in FIGS. 1-4. More specifically, the first connecting member 20 comprises a frontal band or like connecting structure which is disposed in at least partially surrounding relation to the head 14. Moreover, the frontal band or first connecting member 24 is located forwardly of the ears 26 of the head portion 14 of the pet 12 and generally above the “face” and/or eyes of the head portion 14. In contrast, the second connecting member 16 is defined by a rear band, strap, etc. located substantially behind the ears 26 at what may be considered a rear portion of the head 14.

With reference to FIG. 7 and 8, different preferred embodiments of at least one or both of the first and second connecting members 20 or 22 are represented therein. Moreover, in the preferred embodiment of FIG. 7, at least one or alternatively both of the first and second connecting members 20 and 22 comprise a continuous, closed configuration of sufficient dimension and configuration to surround head portion 14 by extending over the frontal and/or rear portions of the head, along each side and underneath the jaw, throat area, or other area of the head portion 14 substantially corresponding to the position of the first and second connecting member, as clearly demonstrated in FIGS. 1-4.

Further, in the embodiment of FIG. 7 the continuous closed configuration is absent any free ends which are demonstrated in the alternative embodiment of FIG. 8. As such, at least one but preferably both the first and second connecting members 20 and 22 may be at least partially formed from an elastic material and dimensioned to accomplish a snug, secure, stable but not uncomfortable surrounding engagement of the head portion 14 by one or both of the first and/or second connecting members 20 and 22. Such a surrounding connection will be comfortably maintained due, at least in part, to the elasticity demonstrated by the material from which one or both of the first and second connecting members 20 and 22 are formed. Accordingly, the first and second connecting members 21 and 22 may each be at least partially formed from an elastic material and comprise the closed, continuous configuration extending in surrounding relation about a corresponding portion of the head 14 or just one of the first or second connecting members may be so formed and disposed.

An alternative but still preferred embodiment of the first and second connecting members are represented as 20′ and 22′ respectively and include at least one but preferably both of the first and second connecting members 20′ and 22′ comprising an elongated configuration absent a closed, contiguous configuration of the preferred embodiment of FIG. 7. Moreover, in the embodiment of FIG. 8, a fastening assembly generally indicated as 27 is attached to each of the free ends, 29, 30 of the connecting members 20′ and 22′. As such, the fastener assembly 27 may comprise any of a variety of different types of fasteners such as, but not limited to, a hook and loop type fastener, buckle, snap, etc. Accordingly, the fastener assembly 27 may serve to adjust the circumferential size of the first and/or second members 20′ and 22′ thereby facilitating a snug, secure, stable connection in surrounding or at least partially surrounding relation to corresponding portions of the head 14 of the pet 12 as also demonstrated in FIGS. 1-4.

With specific reference to the second connecting member 22 and regardless of assuming the structural features of the embodiment of FIG. 7 or 8, an operative placement thereof comprises it being disposed in surrounding relation to the head portion 14 about the area behind the ears, along the sides of the head portion and over a throat area of the head portion, such as generally where a collar of the pet 12 may be normally placed.

Further, in the embodiment of FIG. 8, the connecting members 20′ and 22′ may also be at least partially formed from an elastic material to further facilitate the adjustment of the length thereof to assure a secure, stable but not uncomfortable attachment thereof to the corresponding parts of the head portion 14 about which the first and second connecting members 20′ and 22′ are attached.

Additional structural features of at least one preferred embodiment of the hairpiece assembly 10 includes the provision of at least one but preferably at least two stabilizing members 32 and 34 operatively disposed in the representation of FIGS. 1 and 2, as well as the detailed view of FIG. 6. More specifically, each of the stabilizing members 32 and 34 are disposed in interconnecting relation between the first and second connecting members 20 and 22 and in spaced relation to the base 18. As such, each of the stabilizing members 32 and 34 may be in the form of a strap, band, etc. similar in material to the first and/or second connecting members. Further, the stabilizing members are disposed and structured to at least partially define receiving apertures 36 and 38. Each of the receiving apertures 36 and 38 is further at least partially defined by the correspondingly disposed peripheral portions of the base 18 and the first and second connecting members 20 and 22. Each of the receiving apertures 36 and 38 are disposed, dimensioned and configured to facilitate passage therethrough of corresponding components associated with the predetermined body portion to which the foundation 16 is attached. In the represented embodiments of FIGS. 1-4 each of the receiving apertures 36 and 38 are disposed, dimensioned and configured to receive different ones of the ears 26 of the head portion 14 of the pet 12. Accordingly, the base 18 extends between the ears 26 and the presence of the stabilizing members 32 and 34 and corresponding ones of the receiving apertures 36 and 38 serve to further stabilize and maintain the intended orientation and position of the foundation 16. As such, the hair display or array 24 extending outwardly from the foundation 16 may, depending upon its density substantially cover intended portions of the head 14 or other predetermined portion(s) of the pet body to which the foundation 16 of the hairpiece assembly 10 is connected.

With primary reference to FIG. 5, the plurality of hair segments 23 are connected to various portions of the foundation 16 so as to extend outwardly therefrom. Again, dependent upon the predetermined or selected density of the hair display 24, the number of hair segments 23 may vary as well as their relative placement and/or attachment to the foundation 16.

In order to further facilitate such attachment, various portions of the foundation 16 to which a plurality of hair segments 23 are attached may be formed from an open mesh or net-like material as demonstrated in the more detailed views of FIGS. 5 and 6, as well as the perspective views of FIGS. 1 and 2. In at least one preferred embodiment of the present invention, the plurality of hair segments 23 are attached to a majority if not significantly all of the exposed area of the open mesh of the base 18 as represented. For purposes of clarity, only two of a possible much larger number of hair segments 23 are represented as being attached to the matter demonstrated. Accordingly, the base 18 may be formed in whole or in part from the open mesh or net-like material, wherein the plurality of hair segments 23 are connected thereto so as to extend outwardly therefrom in the manner demonstrated.

However, a plurality of hair segments 23 may also be attached to the first and second connecting members 20 and 22 and possibly the stabilizing members 32 and 34. Therefore, the open mesh or net-like material demonstrated in FIGS. 5 and 6 may be used to form at least a portion of the connecting members 20 and 22 as well as the stabilizing members 32 and 34 as parenthetically represented in FIG. 5. It is further emphasized while the open mesh or net-like material which may form all or a part of the base 18, connecting members 20 and 21 and stabilizing members 32 and 34, these components may be each be formed from materials other than an open mesh or net-like.

FIG. 6 represents yet another preferred embodiment of the hairpiece assembly 10 wherein the base 18′ has a substantially elongated configuration connected at oppositely disposed portions to the first and second connecting members 20 and 22. In addition, overall configuration of the base 18′ may be substantially elliptical so that peripheral sides thereof as at 19 may bow or be curved to extend “inwardly” into the corresponding receiving apertures 36 and 38. This preferred elliptical configuration of the base 18′ may be used to more completely cover the top of the head 14, or other predetermined portion of the pet 12 on which the foundation 16 is positioned. Alternatively, as clearly represented in FIG. 2 the base 18 may include a shape other than the aforementioned elliptical configuration represented in FIG. 6. Therefore, it is emphasized that the specific peripheral and overall configuration of the base 18 and 18′ may be dependent, at least in part, on the shape, size and other physical characteristics of the head 14 or other body portion of the pet 12 corresponding to the base 18 or 18′.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A hairpiece assembly structured for use on pets, said hairpiece assembly comprising:
a foundation structured to be secured to a predetermined body portion of the pet,
said foundation comprising a base dimensioned and configured to overlie at least a part of the predetermined body portion,
said foundation further comprising a first connecting member and a second connecting member each secured to said base in spaced relation to one another,
said first and second connecting members disposed in retaining relation to said base; said retaining relation comprising disposition of said first and second connecting members in at least partially surrounding relation to different parts of the predetermined body portion, and
a plurality of hair segments secured to said foundation and extending substantially outward from and at least partially covering relation to the predetermined body portion.

2. A hairpiece assembly as recited in claim 1 wherein said foundation further comprises at least two stabilizing members disposed in interconnecting relation between said first and second connecting members and in spaced relation to said base.

3. A hairpiece assembly as recited in claim 2 comprising two receiving apertures each disposed between a different one of said two stabilizing members and a corresponding periphery of said base.

4. A hairpiece assembly as recited in claim 3 wherein each of said receiving apertures are disposed and dimensioned to facilitate passage there through of an associated component of the predetermined body portion.

5. A hairpiece assembly as recited in claim 4 wherein each of said receiving apertures are disposed on an opposite side of said base.

6. A hairpiece assembly as recited in claim 1 wherein said base is at least partially formed of an open mesh material.

7. A hairpiece assembly as recited in claim 1 wherein at least one of said first and second connecting members is at least partially formed of an elastic material.

8. A hairpiece assembly as recited in claim 7 wherein said at least one connecting member comprises an elongated configuration of sufficient length to at least partially surround the predetermined body portion.

9. A hairpiece assembly as recited in claim 7 wherein each of said first and second connecting members are at least partially formed of an elastic material.

10. A hairpiece assembly as recited in claim 7 wherein said at least one connecting member comprises an elongated configuration of sufficient length to at least partially surround the predetermined body portion.

11. A hairpiece assembly as recited in claim 10 wherein each of said first and second connecting members comprises an elongated, closed, continuous configuration of sufficient dimension to surround the predetermined body portion.

12. A hairpiece assembly as recited in claim 1 wherein said base comprises a substantially elliptical configuration.

13. A hairpiece assembly as recited in claim 12 wherein said base comprises a substantially open mesh construction.

14. A hairpiece assembly as recited in claim 1 wherein at least one of said first and second connecting members includes a fastener assembly disposed and structured to removably attach corresponding free ends of said one connecting member.

15. A hairpiece assembly as recited in claim 14 wherein said at least one connecting member is disposed in substantially surrounding relation to a part of said body predetermined body portion when said fastener assembly is disposed in connecting relation to said corresponding free ends.

16. A hairpiece assembly structured for use on pets, said hairpiece assembly comprising:
a foundation structured to be secured to a head portion of the pet and including a base disposed in overlying relation to at least a part of the head portion,
said foundation further comprising a first connecting member and a second connecting member each secured to said base in spaced relation to one another,
said first and second connecting members disposed in retaining relation to said base, said retaining relation comprising disposition thereof in at least partially surrounding relation to different parts of the head portion, and
a plurality of hair segments secured at least to said base and extending outwardly there from in collectively covering relation to at least some of the head portion.

17. A hairpiece assembly as recited in claim 16 wherein said base is dimensioned and configured for placement at least partially between the ears of the head portion.

18. A hairpiece assembly as recited in claim 17 wherein said base is at least partially formed of an open mesh material structured to facilitate connection of said plurality of said hair segments thereto.

19. A hairpiece assembly as recited in claim 17 wherein said base comprises a substantially elliptical configuration.

20. A hairpiece assembly as recited in claim 16 further comprising at least two stabilizing members disposed in interconnecting relation between said first and second connecting members and in spaced relation to said base.

21. A hairpiece assembly as recited in claim 20 further comprising two receiving apertures each disposed between a different one of said two stabilizing members and a corresponding periphery of said base.

22. A hairpiece assembly as recited in claim 21 wherein peripheral portions of each of said receiving apertures are disposed in surrounding relation to a different ear of the head portion.

23. A hairpiece assembly as recited in claim 16 wherein at least one of said connecting members comprises a closed, continuous configuration and is disposed in surrounding relation to the head portion.

24. A hairpiece assembly as recited in claim 23 wherein said one connecting member is at least partially formed of an elastic material.

25. A hairpiece assembly as recited in claim 15 wherein each of said first and second connecting members comprises a closed, continuous configuration and is disposed in surrounding relation to different parts of the head portion.

26. A hairpiece assembly as recited in claim 16 wherein at least one of said first and second connecting members includes a fastener assembly disposed and structured to removably attach corresponding free ends of said at least one connecting member.

27. A hairpiece assembly as recited in claim 26 wherein said connecting member is disposed in substantially surrounding relation to a portion of the head portion when said fastener assembly is disposed in connecting relation to said corresponding free ends.

28. A hairpiece assembly as recited in claim 16 wherein said plurality of hair segments are further connected to said first and second connecting members and extend outwardly there from in collectively covering relation to corresponding parts of the head portion.
